(19) United States
(12) Patent Application Publication
(10) Pub. No.: US 2007/0180275 A1
(43) Pub. Date: Aug. 2, 2007

(54) Transparent encryption using secure JDBC/ODBC wrappers

(76) Inventors: Brian Metzger, San Jose, CA (US); Stephen Mauldin, San Francisco, CA (US); Bruce Sandell, Mountain View, CA (US); Mark Delaney, Mountain View, CA (US)

Correspondence Address: PERKINS COIE LLP, P.O. BOX 2168, MENLO PARK, CA, 94026, US

(21) Appl. No.: 11/341,060

(22) Filed: Jan. 27, 2006

(51) Int. Cl. G06F 12/14

(52) U.S. Cl. 713/194

(57) ABSTRACT

A system and method for selectively encrypting and decrypting data in any given target database from a plurality of databases in a manner that is transparent to application programs that access data in such databases is described.

### CROSS-REFERENCE TO RELATED APPLICATIONS

The present application is related to the following applications the entire contents of which are hereby incorporated by reference as if fully set forth herein. The related applications are: U.S. patent application Ser. No. 11/236,061, filed Sep. 26, 2005, entitled, TRANSPARENT ENCRYPTION USING SECURE ENCRYPTION DEVICE by inventors, Brian Metzger, Stephen Mauldin, Bruce Sandell, and Jorge Chang; U.S. patent application Ser. No. 11/236,294, filed Sep. 26, 2005, entitled, DATA MIGRATION by inventors, Brian Metzger, Stephen Mauldin, Bruce Sandell, and Jorge Chang; and U.S. patent application Ser. No. 11/236,046, filed Sep. 26, 2005, entitled, KEY ROTATION by inventors, Brian Metzger, Bruce Sandell, Stephen Mauldin and Jorge Chang.

### TECHNICAL FIELD

The present invention is directed to data security, and more specifically to protecting selected columns of data within a database in a manner that is transparent to applications that access the encrypted database.

### BACKGROUND

Not only is data security a feature that is highly desired by customers but it is also needed to comply with certain data security regulations. In the case of databases, it is highly desirable to encrypt the data before storing in the databases.

In one approach, the keys required for decryption of data are stored in physical files on the same computer on which the database server resides. Such an approach allows an attacker who is successful in compromising the security of the database server to gain access to the encrypted data in the database by accessing the encryption keys stored on the database server.

It is also desirable to have the ability to selectively encrypt certain columns of the stored database tables rather than encrypting all of the columns of all of the database tables, if so desired. However, in order to provide column level encryption for a database requires extensive changes to the application programs that wish to access the encrypted data in the database. Such an approach is inconvenient and would require considerable time and effort to implement such a solution.

### BRIEF DESCRIPTION OF THE DRAWINGS

FIG. 1 is a block diagram that illustrates the communication that allows an application program to access unencrypted data in a database.

FIG. 2 is a block diagram that illustrates the communication that allows an application program to access encrypted data in a database.

FIG. 3 is a high-level flowchart that illustrates a manner in which an application program can access encrypted data in a database.

FIG. 4 is a high-level flowchart that illustrates a manner in which an application program can input encrypted data in a database.

### DETAILED DESCRIPTION

According to certain embodiments, a mechanism is used to selectively encrypt and decrypt data in any given target database from a plurality of databases in a manner that is transparent to application programs that access data in such databases. In other words, the application programs can seamlessly access encrypted data with little or no change to the application program.

According to certain embodiments, a mechanism is used to intercept requests made by requesting application programs for data from a target database. According to certain embodiments, such a mechanism is a wrapper that is written on top of an existing JDBC/ODBC driver. The wrapper intercepts requests from requesting application programs, which requests are destined for a database driver that communicates with the target database server. The wrapper determines if the intercepted request is a request for encrypted data stored in the target database. In the case where the request references data in encrypted columns in the target database, the wrapper causes the requesting user to be authenticated and causes the verification of whether the requesting user is authorized to access encrypted data in the database, according to certain embodiments. Next, the wrapper constructs a modified request based on modification information from a network-attached encryption/decryption mechanism, and sends the modified request to the appropriate database driver for execution, according to certain embodiments. Upon receiving the data in response to the request for data, the database driver attempts to send the requested data to the requesting application program.

According to certain embodiments, the wrapper intercepts the encrypted data sent by the database driver to the requesting application program. The wrapper causes the decryption of the encrypted data by sending the encrypted data to a decryption mechanism, according to certain embodiments. After decryption, the wrapper then sends the decrypted data to the requesting application program.

According to certain embodiments, when a requesting application program is making a request to input data into a database and the input data references encrypted columns in the database, a mechanism is used to intercept the request to input data. Such a mechanism causes the input data to be encrypted and modifies the request to refer to the now encrypted data before sending the request to the appropriate database driver for execution, according to certain embodiments. The appropriate database driver executes the modified request by interacting with the database server in order to input the encrypted data in the appropriate encrypted database table.

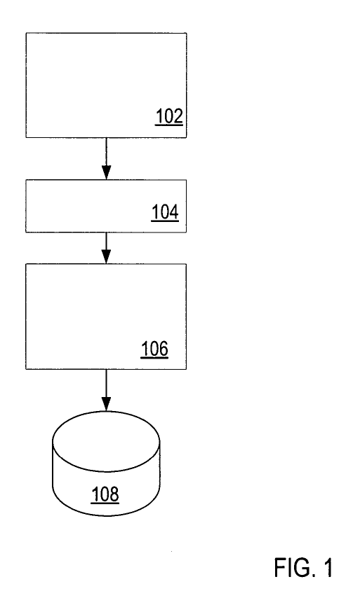

FIG. 1 is a block diagram that illustrates the communication that allows an application program to access unencrypted data in a database. In FIG. 1, application program 102 accesses data by communicating with a database driver 104. Database driver 104 communicates with the database server 106 that is associated with the target database 108. Database driver 104 is communicatively coupled to database server 106 through a network. Database driver 104 links application program 102 to the database server 106. Some examples of appropriate networks are the Internet, a WAN, a LAN, etc. The communications between the components in FIG. 1 may be web-based. Different types of database drivers may be used depending on the nature of the application program. For example, the database driver may be a Java database connectivity application program interface (API) between a Java platform application program and a SQL based database server. An example of such an API is JDBC (Java Database Connectivity). The JDBC API enables Java programs to execute SQL statements. In this manner, any JDBC supported application program can interact with any SQL compliant database server with the aid of a JDBC API. Another type of database driver may be a Microsoft Open Database Connectivity (ODBC) API. The ODBC API includes a set of functions that provide any ODBC-supported application program with access to SQL compliant database servers.

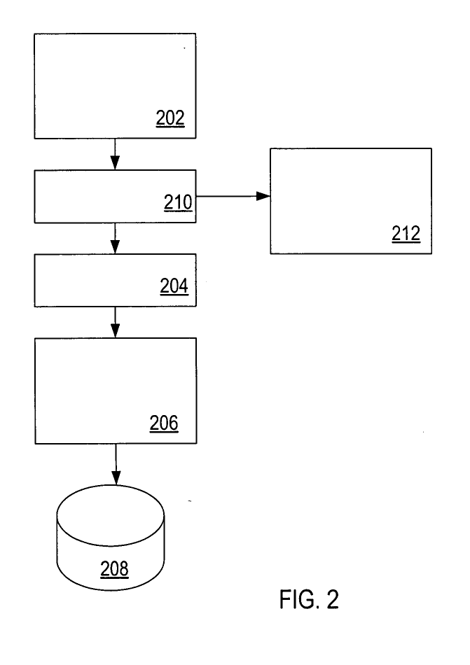

FIG. 2 is a block diagram that illustrates the communication that allows an application program to access encrypted data in a database. In FIG. 2, application program 202 accesses data by communicating with database driver 204. However, the communications from application program 202 are intercepted by wrapper 210. Wrapper 210 is adapted to communicate with a network attached encryption/decryption mechanism 212. The network attached encryption/decryption mechanism 212 may be a server. The keys for encrypting and decrypting data are securely stored at the network attached encryption/decryption mechanism 212, according to some embodiments. According to certain other embodiments, the keys for encrypting and decrypting data are securely stored at a separate secure device that is accessible by the network attached encryption/decryption mechanism 212.

Database driver 204 communicates with the database server 206 that is associated with the target database 208. Database driver 204 is communicatively coupled to database server 206 through a network.

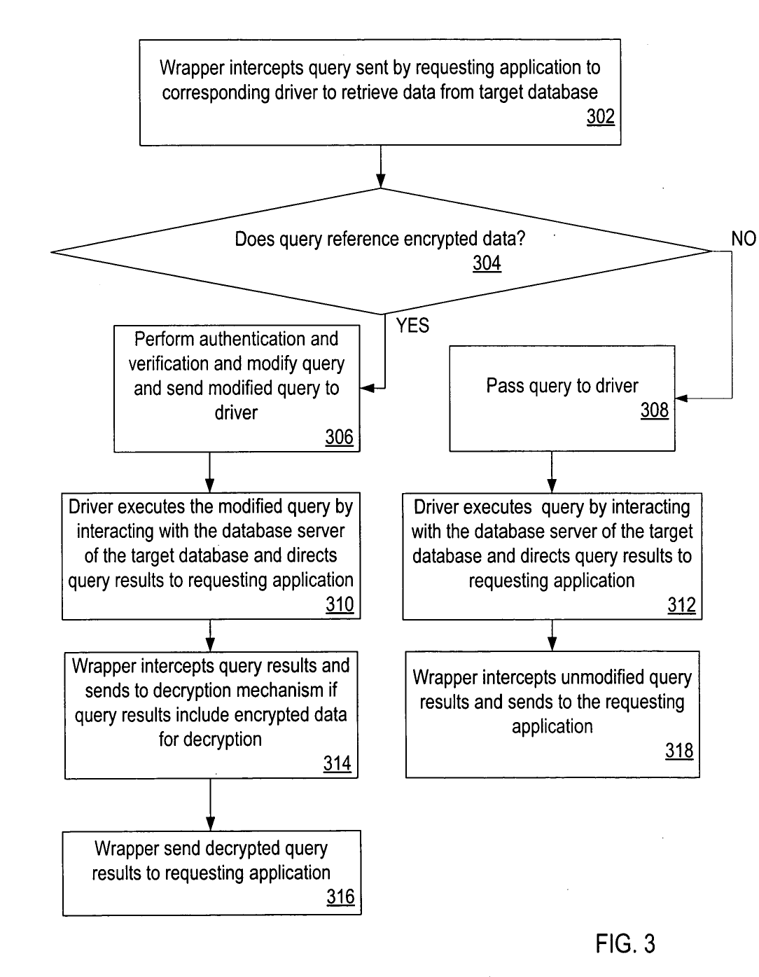

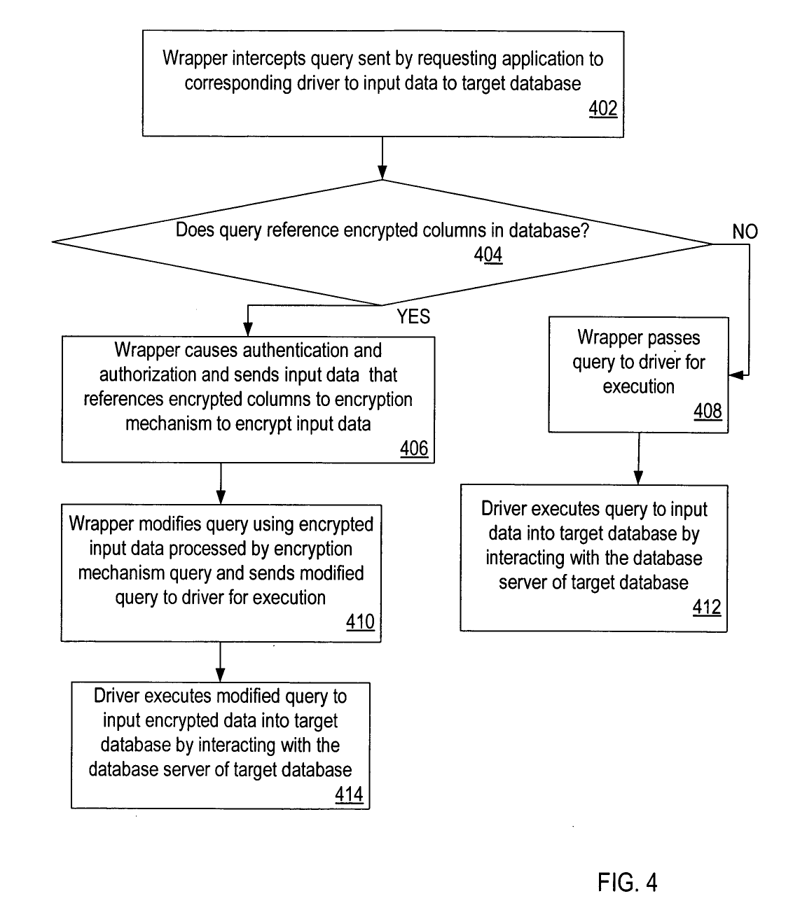

In FIG. 2 only one application program and one target database is shown. There may be a plurality of application programs and databases and may vary from implementation to implementation. If ODBC-supported application programs are used, then there is at least one ODBC database driver that is used for linking the ODBC-supported application programs to the one or more SQL database servers. Similarly, if JDBC supported application programs are present, then there is at least one JDBC database driver that is used for linking the JDBC supported application programs to the one or more SQL database servers. It is to be noted that the embodiments are limited neither to ODBC-supported application programs nor to JDBC supported application programs. Depending on the nature of the database driver, a corresponding wrapper is used for intercepting communications between the application program and the database driver in a manner to allow the application program to access encrypted data in a given target. The function of the wrapper is described in greater detail with reference to FIG. 3 and FIG. 4.

FIG. 3 is a high-level flowchart that illustrates a manner in which an application program can access encrypted data in a database. For purposes of explanation, assume that an application program such as application program 202 of FIG. 2 is attempting to retrieve data from a target database such as database 208 of FIG. 2. The application program that is attempting to access the target database is referred to as the requesting application with reference to FIG. 3 and FIG. 4. Assume that the requesting application sends a query that is directed to the database driver such as database driver 204.

At block 302, a wrapper intercepts the query sent by the requesting application to the corresponding database driver to retrieve data from the target database. At block 304, the wrapper determines whether the intercepted query references data that is stored in an encrypted column of a database table in the target database. The wrapper uses a query parser, such as a SQL parser if the query is a SQL query, for parsing the query. According to certain embodiments, the query parser may reside on a network attached encryption/decryption (NAE) mechanism, such as network attached encryption/decryption mechanism 212 of FIG. 2. In such a case, the wrapper sends the query to the NAE mechanism to be parsed.

If the intercepted query references data that is stored in an encrypted column, then at block 306, the wrapper causes the authentication of the requesting user and causes the verification of whether the requesting user is authorized to access the encrypted column. In other words, the user is authenticated through the NAE server, and it is determined if the user has permission to use the encryption key for encrypting data. Further, if at the NAE server, it is determined that the query needs modification, the NAE server sends the modification information back to the wrapper. The wrapper then constructs a modified query based on the modification information received from the NAE server. For example, based on the modification information received from the NAE server, the wrapper modifies the intercepted query to refer to the appropriate encrypted column in the target database. Next, the wrapper sends the modified query to the database driver.

At block 310, the database driver parses and executes the modified query by interacting with the database server that is associated with the target database. According to certain embodiments, the database driver uses the query parser that resides on the NAE mechanism to parse the query for execution. In certain other embodiments, the database driver may include an implementation of a query parser. The database server satisfies the modified query and sends the query results to the database driver. The database driver then directs the query results to the requesting application.

At block 314, the wrapper intercepts the query results that are directed to the requesting application. The wrapper causes the encrypted data in the query results to be decrypted. For example, the wrapper can send the encrypted data to the NAE mechanism for decryption. At block 316, the wrapper sends the decrypted query results to the requesting application.

If at block 304, the wrapper determines that the intercepted query does not reference encrypted data, then at block 308 the wrapper passes the query to the database driver without modification. Next at block 312, the database driver executes the unmodified query and interacts with the database server associated with the target database to obtain query results. The database driver directs the query results to the requesting application. At block 318, the wrapper intercepts the query results and sends the query results to the requesting application.

FIG. 4 is a high-level flowchart that illustrates a manner in which an application program can input encrypted data in a database. For purposes of explanation, assume that an application program such as application program 202 of FIG. 2 is attempting to input data to an encrypted column in the target database such as database 208 of FIG. 2. Assume that the requesting application directs a query for inputting data to the database driver such as database driver 204.

At block 402, a wrapper intercepts the query sent by the requesting application to the corresponding database driver to input data to the target database. At block 404, the wrapper determines whether the intercepted query is for inputting data to an encrypted column of a database table in the target database. The wrapper uses a query parser, such as a SQL parser if the query is a SQL query, for parsing the intercepted query. According to certain embodiments, the query parser may reside on a network attached encryption/decryption (NAE) mechanism, such as network attached encryption/decryption mechanism 212 of FIG. 2. In such a case, the wrapper sends the intercepted query to the NAE mechanism to be parsed.

If the intercepted query is for inputting data to an encrypted column in the target database, then at block 406, the wrapper causes the authentication of the requesting user and causes the verification of whether the requesting user is authorized to access the encrypted column. Then, the wrapper sends the input data from the intercepted query to an encryption mechanism such as the NAE mechanism 212 of FIG. 2. The NAE mechanism encrypts the input data and returns the encrypted data to the wrapper. At block 410, the wrapper modifies the intercepted query based on the encrypted input data received form the NAE mechanism and sends the modified query to the database driver for execution.

Alternatively, the wrapper, at block 406, may send the entire intercepted query to the NAE mechanism for encrypting the input data and modification of the query, after completing the appropriate authentication and authorization procedures. In such a case, at block 410, the wrapper will simply forward the modified query received from the NAE mechanism to the database driver for execution. At block 414, the database driver executes the modified query to input the now encrypted input data into the target database by interacting with the database server associated with the target database.

If at block 404, the wrapper determines that the intercepted query does not reference any encrypted columns in the target database, then at block 408, the wrapper passes the query without modification to the database driver for execution. At block 412, the database driver executes the query to input data into the target database.

According to certain embodiments, metadata tables may be used to store information about each encrypted database table of the target database. The metadata tables can contain detailed information on each encrypted column of each encrypted database table. The metadata tables may also contain encrypted information on the properties of the NAE server. The properties of the NAE server include user name, password, IP address, port and protocol information for connecting to the NAE server. Further, a GUI may be implemented for configuring the metadata tables and for enabling/disabling the wrapper, according to some embodiments.

In the foregoing specification, embodiments of the invention have been described with reference to numerous specific details that may vary from implementation to implementation. The specification and drawings are, accordingly, to be regarded in an illustrative rather than a restrictive sense.

We claim:

1. A computer-implemented method for selective encryption of data for storing in a database of a plurality of databases in a manner that is transparent to a plurality of application programs that use said data, said method comprising:
intercepting communications between said plurality of application programs and a database connectivity driver that provides said plurality of application programs with connectivity to one or more databases of said plurality of databases;
determining if said intercepted communications reference encrypted data associated with said database; and
modifying said intercepted communications when said intercepted communications reference encrypted data associated with said database.

2. The computer-implemented method of claim 1, further comprising authenticating and authorizing said plurality of application programs when said intercepted communications reference encrypted data associated with said database.

3. The computer-implemented method of claim 1, further comprising using an NAE mechanism that is adapted for encrypting and decrypting data that is associated with said intercepted communications.

4. The computer-implemented method of claim 3, further comprising using a query language parse engine at said NAE mechanism.

5. The computer-implemented method of claim 4, wherein said parse engine is a SQL parse engine.

6. The computer-implemented method of claim 1, further comprising using a database connectivity API.

7. The computer-implemented method of claim 6, wherein said database connectivity API includes a JAVA® Database Connectivity (JDBC).

8. The computer-implemented method of claim 6, wherein said database connectivity API includes a Microsoft® Open Database Connectivity (ODBC).

9. The computer-implemented method of claim 1, further comprising using metadata tables for storing encryption information about encrypted database tables associated with said plurality of databases.

10. The computer-implemented method of claim 9, wherein said metadata tables are stored in said corresponding database where said encrypted database tables are stored.

11. The computer-implemented method of claim 1, further comprising using a GUI for configuring metadata tables for storing encryption information about encrypted database tables associated with said plurality of databases and for enabling and disabling said interception of communications.

12. A system for encrypting data in a database, the system comprising:
a wrapper that is adapted to intercept communications between application programs and a database driver; and
a network attached encryption and decryption mechanism that is adapted for use with said wrapper.

13. The system of claim 12, further comprising metadata tables for storing encryption information about encrypted database tables associated with said database.

14. The system of claim 13, wherein said metadata tables are stored in said corresponding database where said encrypted database tables are stored.

15. The system of claim 12, further comprising a GUI for configuring metadata tables for storing encryption information about said encrypted database tables and for enabling and disabling said wrapper.

16. The system of claim 12, further comprising a query language parse engine for parsing said intercepted communications.

17. A transparent encryption mechanism for encrypting data in a database, the encryption mechanism comprising:
a means for intercepting communications between application programs and a database driver; and
a means for modifying said intercepted communications said intercepted communications reference encrypted data.

18. The encryption mechanism of claim 17, further comprising a means for encrypting and decrypting data associated with said database.

19. The encryption mechanism of claim 17, further comprising a means for parsing said communications.

20. The encryption mechanism of claim 17, further comprising a means for storing encryption information about said encrypted columns associated with said database.
